(19) United States
(12) Patent Application Publication
(10) Pub. No.: US 2022/0030902 A1
(43) Pub. Date: Feb. 3, 2022

(54) SLICEABLE SOLID

(71) Applicant: SAVENCIA SA, VIROFLAY (FR)

(72) Inventors: Fabien DURAND, Razac sur L'Isle (FR); Virginie PADEL, Favieres (FR); Alice CIBRARIO, Versailles (FR)

(73) Assignee: SAVENCIA SA, VIROFLAY (FR)

(21) Appl. No.: 17/390,336

(22) Filed: Jul. 30, 2021

(30) Foreign Application Priority Data
Jul. 31, 2020 (FR) FR2008200

(51) Int. Cl. A23C 20/02; A23L 25/00; A23L 29/00; A23L 19/12; A23L 19/10

(52) U.S. Cl. CPC A23C 20/025; A23L 25/30; A23L 19/11; A23L 29/015; A23L 19/13; A23L 29/04

(57) ABSTRACT

The present invention relates to the field of the food industry; it is aimed more particularly at the preparation of food products, sliceable solids, composed of vegetable ingredients and having organoleptic properties close to those of dairy products.

The present invention relates to the field of the food industry; it is aimed more particularly at the preparation of food products, sliceable solids, composed of vegetable ingredients and having organoleptic properties close to those of dairy products.

Whether for ethical conviction or nutritional reasons, the demand for vegetarian or even vegan food products is constantly growing. There are, however, food products whose manufacture by definition requires the use of ingredients of animal origin, as is the case with mammalian milk for the preparation of dairy products such as the cheese.

The objective of the applicant is to develop food products analog to dairy products from vegetable raw materials in order to generate products compatible with a vegan diet while remaining in the organoleptic world of dairy products such as unrefined sliceable cheeses in terms of appearance, texture and taste. By unrefined sliceable cheese is meant solid products without a live crust that are firm enough to be sliced and conserve at least part of their shape during their respective use. This comprises in particular salad cheese products such as feta and mozzarella analogs; grippable cheeses such as melted portion analogs, pressed dough analogs (e.g. in the form of blocks, slices, or shredded) and toastinettes (which may also be known as individually wrapped slices (IWS) or slice on slice (SOS)) burger analogs, or even fresh logs and soft dough analogs. Cheese analog, for example feta and mozzarella, refers in particular to vegetable products that aim to reproduce the textural and/or sensory attributes of these dairy referents.

This implies very specific rheological characteristics to meet the requirements of the product uses.

The cheeses are a category of fresh dairy products obtained from liquid milk, a colloidal medium composed of proteins of submicron size, lipid globules, sugars and mineral salts. The milk is potentially enriched with cream or other dairy derivates and then subjected to a thermal treatment (thermization or pasteurization) and/or physical treatment (microfiltration) in order to be coagulated enzymatically (rennet) and/or microbiologically (lactic acid bacteria in particular). The curd is then mechanically broken, drained and/or pressed and eventually refined to produce a variety of cheeses such as soft dough, pressed dough, etc. The curds can also be mixed with other ingredients (dairy proteins, cream, spices, fine herbs, salt, etc.) and then subjected to thermomechanical treatments to obtain cheese specialties, which have a fresh cheesy taste (or fresh cheese), a white color and a more or less smooth appearance.

The cheese analogs are defined as products obtained by mixing different ingredients such as proteins and fats, of dairy or non-dairy origin, and formulated to meet a specific functional need (Bachman, H. P., 2001, “Cheese analogues: a review”, International Dairy Journal, Volume 11, 505-515). Historically, these products have been formulated with an objective of reducing costs, in particular with the pizza cheeses. More recently, the segment of the vegetable analogs aiming to reproduce the appearance and taste characteristics of the different cheeses has experienced a strong commercial expansion, and different products are available on the market with various formulation strategies.

The vegetable cheese analogs obtained by emulsifying fat in an aqueous phase containing starches are known, for example the brand products Violife®, Nurishh®, Valio Oddlygood®, Simply V®, Bedda®, Superbom® or Green Vie®. These products have a low protein content (between 0 and 1%) and their texturing is ensured by the joint use of fats, starches and additives of the hydrocolloid type (modified starches, xanthan gum, locust bean gum, methyl cellulose, agar-agar, etc.). Various other additives are frequently used for their acidifying, coloring or preserving function: citric acid (E330), glucono-delta-lactone (E575), tricalcium citrate (E333), sodium ascorbate (E301), sorbic acid (E200), beta-carotene (E160a), etc. The products come in various forms such as blocks, balls, slices or shredded. From a nutritional point of view, these products are far removed from the dairy referents with a very unfavorable fat to protein ratio.

There are also products obtained from vegetable raw materials that have undergone various treatments such as hulling, thermal treatments, grinding, fermentation and even germination. These vegetable raw materials are mainly seeds such as rice (Mozzarisella® product), soybean (vegetable alternative to Soyananda® brand Greek cheese) and nuts. Among the nuts, the cashew nut is the most frequently used. For example, there are parmesan analogs obtained by directly dry crushing nuts, mainly cashew nuts, and adding aromatic molecules (Wege Siostry®, Good Carma® or Willicroft® brand products). These products are essentially anhydrous and have a very high caloric value, between 500 and 550 kcal/100 g) and come in the form of powders or flakes.

It is also known to implement large quantities of crushed cashew nuts, add water and then ferment the suspension with lactic acid bacteria. The products of the Happy Cashew® brand, Euro Company® (Fermè®, Cicioni®, Camelia®) brand, correspond to this production method. The caloric value is high, usually between 400 and 500 kcal/100 g, due to the high dry extract of these products. They are generally perceived by the consumers as dry in the mouth, lacking a sensation of freshness, due in particular to the low humidity perceived at the time of the consumption.

Some other nut-based products have a lower dry extract but use various additives (texturizers, acidifiers, preservatives, etc.) to texturize the product and ensure its conservation over time. This is the case in particular with the almond-based product Mondarella®, the almond-based cottage cheese under the Yogan® brand or, for example, the cashew-based product Veganella® by Soyana®. These products, because of the presence of additives in the list of ingredients, are then distinguished from the dairy references with non “Clean Label” formulations.

In conclusion, the vegetable analogs of the prior art are most often
either starch gels in which the fat is emulsified, with a very low protein content (<1 g/100 g).
or concentrated suspensions of nuts having a high dry extract, resulting in a high protein content and a high caloric value.

It should be noted, however, that adding water to said concentrated suspensions to overcome the above-mentioned disadvantages gives rise to texturing problems which very generally require the use of texturizing additives.

One of the objectives of the applicant is to obtain solid, unrefined vegetable cheeses from crushed nuts having in particular a protein content of 3% or more, without the addition of additives and another additional protein source such as concentrates or isolates.

Another objective of the present invention is to obtain solid vegetable cheeses having an aromatic profile devoid of undesirable notes, i.e. in particular notes not belonging to the notes of the cheese world, in particular by adding raw materials fermented by strains of interest.

Yet another objective of the present invention is to provide solid vegetable cheeses without resorting to fermentation intended to texture the starting composition to form said cheeses.

The obtaining of vegetable analogs of dairy products poses many technical problems.

It is in particular difficult to obtain a product with a dairy or cheesy typicity from vegetable raw materials, in particular the white color which allow to remind the world of the cheese.

Another problem is to completely free ourselves from animal raw materials, such as dairy proteins or eggs, whose texturizing, binding, gelling, stabilizing, emulsifying, whipping, etc. functionality could be put to good use.

A similar technical problem is to have a finished product without additives such as emulsifiers, acidifiers/acidity correctors, gums and other hydrocolloids (modified starches, xanthan gum, locust bean gum, methyl cellulose, agar-agar, etc.), ingredients commonly used in the vegan cheeses for their texturizing and stabilizing functionality: the texturizers modify the rheological behavior of the cheese analogs, making them more or less firm, grippy, breakable, gel-like, etc. They also have a stabilizing role through their ability to bind free water, thus limiting the risks of syneresis (water exudation) on the finished product, a phenomenon perceived as a quality defect. Another major technical problem for the sliceable products such as pressed dough is to find the two specific textural properties of this category, i.e. the firmness and the deformability, without using any additives. The levers that allow these characteristics to be recovered are often diametrically opposed and the absence of additives does not allow the textures identical to the dairy references to be recovered. It is indeed very complex to combine firmness and deformability because firmness is often synonymous with breakable whereas the deformability is often linked to soft products.

The identification of specific technical solutions to this problem was therefore key to find textures that were more or less deformable, firm and sliceable, and thus generating a world of large and varied textures for different uses.

It is also difficult to obtain unrefined cheese analogs with sensory profiles of dairy products without vegetable typicity in order to get as close as possible to the organoleptic world of the dairy referents . . . . The aromatic profile often comprises detectable vegetable notes and may not be suitable for some consumers looking for a sensory experience similar to that of a dairy product.

Thanks to a specific selection of vegetable raw materials, coupled with a mastery of a method allowing the generation of analogs of unrefined solid cheeses, the Applicant has succeeded in preparing food products composed of vegetable raw materials and which present organoleptic qualities reproducing those of unrefined solid cheeses without resorting to the use of food additives while having an equivalent or improved nutritional profile compared to the other vegetable products already available on the market.

Advantageously, this selection of vegetable raw materials allows to offer products having a significant protein content (in particular greater than or equal to 3%), a moderate fat content (less than 25%) and which may have saturated fatty acid contents (less than 5%) and food fibre contents (greater than or equal to 3%), based on “Clean Label” formulations, i.e. without food additives. Depending on the choice of the fat and the added fibre content, it is then possible to achieve nutritional profiles equivalent or even superior to cheese equivalents, in this case via a Nutri-Score A to D. The Nutri-Score is a nutritional quality assessment tool introduced in 2016 in France in the scope of the National Nutrition and Health Plan. According to its nutritional characteristics, a food product obtains a Nutriscore score ranging from A (the most nutritionally favorable products) to E (the least favorable products, whose consumption should be limited).

The absence of texturizing additives (modified starches, agar, carob, xanthan, carrageenans, cellulose derivatives, etc.) in the formulas also had to be compensated for by ingredients of the starch and/or flour type. This compensation is not without consequences and has led in particular to two new technical problems:
An organoleptic degradation of the product with an increase in undesirable vegetable tastes and odors and a loss of whiteness. In fact, in addition to the vegetable notes and colorings that are classically more pronounced in ingredients such as flour or starch than in texturizing agents such as additives, the contents incorporated for a similar texturizing effect are much higher, which worsens the organoleptic defects of taste and color. It is then important to choose ingredients that allow to limit/remove these defects.
A greater evolution of the texture during the service life of the product with in particular phenomena of retrogradation of the starch observed, synonymous with an increase in firmness during the conservation at 4-6° C.

The present invention also allows to solve the problem of the composition of most of the vegetable “cheeses” which contain very little (<1%) protein. The products according to the invention classically contain between 3 and 10% by weight of protein without requiring the addition of protein concentrate or isolate and therefore have an improved nutritional and organoleptic profile compared to the vegan cheeses of the prior art, with Nutri-Score scores from A to D for the preferred values.

Finally, the present invention allows to overcome the problems of taste, color and texture defects frequently found in the vegetable analogs of cheese. Contrary to the products currently on the market, the products resulting from this invention are very close to the dairy equivalents on these 3 criteria.

Obtaining solid and melting textures for Vegan products, in particular those with a vegetable protein content of 3% or more, without texturizers or stabilizers, remains a major technical difficulty. The present invention thus allows to respond to this problem through the implementation of formulae levers and methods that generate textures without floury defects.

Similarly, obtaining a creamy-white appearance with a significant protein content is a real difficulty but remains an essential element in recalling the cheese equivalent. There are many Vegan products on the market that look white but are based on formulations such as water+oil+texturizers and therefore without protein. Here again, in order to get around this technical difficulty, formulae levers (choice of the right raw materials) and methods (mixing and homogenization steps) have allow to obtain an appearance identical to that of unrefined solid cheese analogs.

The present invention thus relates to a vegetable food product analogous to unrefined solid cheeses, comprising:
crushed nuts, preferably in the form of puree and preferably almond puree; added with:
at least one vegetable fat;
at least one source of starch;
at least one natural acidifying ingredient;
optionally, at least one source of vegetable food fibres; and
water;
   characterized in that it contains no added additives.

By “no added additives” is meant in particular the absence of additives declared in the list of ingredients of said vegetable food product, in particular on the pack of said vegetable food product.

For example, the salt (which may be an ingredient of said vegetable food product) may contain one or more anti-caking agents, which are not added additives.

The added additive is in particular a food additive, as for example defined below.

According to an embodiment, the vegetable food product has a protein content greater than or equal to 3%.

According to a particular embodiment, the vegetable food product contains between 3 and 12% protein, and more preferably between 4 and 10% protein.

According to a particular embodiment, the vegetable food product does not comprise protein concentrate and/or isolate, in particular protein concentrate and isolate.

It should be noted that the vegetal notes brought by these proteins at high dosage can often degrade the organoleptic profile of the finished products.

By “concentrate” is meant in particular a concentrate as defined in the Codex Alimentarius, in particular a product containing more than 65% and less than 90% protein.

By “isolate” is meant in particular an isolate as defined in the Codex Alimentarius, in particular a product containing 90% or more protein.

According to an embodiment, the vegetable food product does not comprise a protein source other than the crushed nuts.

According to an embodiment, the vegetable food product does not comprise soybean.

Indeed, it appears that some consumers may have reservations about products containing soybean.

By “natural acidifying ingredient” is meant, for example, a citrus-based ingredient, in particular lemon or grapefruit.

According to one embodiment, the natural acidifying ingredient is a concentrated lemon juice or concentrated grapefruit juice or other citrus fruit acidifier, in particular a concentrated lemon juice acidifier.

More specifically, the present invention relates to a vegetable food product comprising (percentages expressed by weight with respect to the total weight of the product):
from 5 to 40%, preferably between 13% and 30% of crushed nuts, preferably in the form of a puree. The particles of said puree preferably have a median particle size measured by laser particle size measurement of less than or equal to 50 μm;
from 5 to 35% of vegetable fat, preferably from 5 to 30% and even more preferably from 5 to 20%;
from 0.5 to 20%, preferably 1 to 15%, of a starch source such as vegetable flour or starch;
up to 30% of other raw materials, preferably vegetable, such as vegetable or fruit purees or pieces, cereals, seeds or herbs, aromas;
up to 8% of vegetable food fibres;
optionally, a natural source of calcium, preferably of the Lithothamnion type, in particular at a content of between 0.5 and 1%;
up to 3.5% of a natural acidifying ingredient, in particular an acidifier of the concentrated lemon juice or concentrated grapefruit juice or other citrus fruits type; according to a particular embodiment which does not use a source of natural calcium, the acidifier can be used in a lower content which can be up to 1.8%;
up to 2.5%, preferably less than 2% of food salt;
optionally, up to 1% of ferments; if the ferment is used to ferment all or part of the crushed nut, its content may be reduced to 0.2%;
water, between 40% and 75%, preferably around 55%.

The other raw materials, preferably vegetable, are for example vegetable or fruit purees or pieces, in particular fruits. The fruits are, for example, one or more red fruits, such as in particular raspberry; pineapple; tomato; or mixtures thereof.

This product is characterized by:
a dry extract content of between 20 and 55%, preferably between 30 and 55%;
a pH between 4.0 and 5.2;
characteristics of a cheese product, in particular a white to yellow color, a more or less smooth appearance, a more or less firm and/or deformable rheology and/or a fresh to cheesy taste.

According to an embodiment, the present invention relates to a vegetable food product comprising (percentages expressed by weight with respect to the total weight of the product):
from 5 to 40%, preferably between 13% and 30% of crushed nuts, preferably in the form of a puree. The particles of said puree preferably have a median particle size measured by laser particle size measurement of less than or equal to 50 μm;
from 5 to 35% of vegetable fat, preferably from 5 to 30% and even more preferably from 5 to 20%;
from 0.5 to 20%, preferably 1 to 15%, of a starch source such as vegetable flour or starch;
up to 3.5% of a natural acidifying ingredient, in particular an acidifier of the concentrated lemon juice type; according to a particular embodiment which does not use a source of natural calcium, the acidifier may be used in a lower content which may be up to 1.8%;
up to 2.5%, preferably less than 2% of food salt;
water, between 40% and 75%, preferably around 55%.

According to an embodiment, the present invention relates to a vegetable food product comprising (percentages expressed by weight with respect to the total weight of the product):
from 5 to 40%, preferably between 13% and 30% of crushed nuts, preferably in the form of a puree. The particles of said puree preferably have a median particle size measured by laser particle size measurement of less than or equal to 50 μm;
from 5 to 35% of vegetable fat, preferably from 5 to 30% and even more preferably from 5 to 20%;
from 0.5 to 20%, preferably 1 to 15%, of a starch source such as vegetable flour or starch;
up to 30% of other raw materials, preferably vegetable, such as vegetable or fruit purees or pieces, cereals, seeds or herbs, aromas;
up to 8% of vegetable food fibres;
up to 3.5% of a natural acidifying ingredient, in particular an acidifier of the concentrated lemon juice type; according to a particular embodiment which does not use a source of natural calcium, the acidifier may be used in a lower content which may be up to 1.8%;
up to 2.5%, preferably less than 2% of food salt;
water, between 40% and 75%, preferably around 55%.

According to an embodiment, the present invention relates to a vegetable food product analogous to unrefined solid cheeses, in particular toastinettes (which may also be known as individually wrapped slices (IWS) or slice on slice (SOS)) or pressed doughs, comprising (percentages expressed by weight with respect to the total weight of the product):
from 15 to 25% of crushed nuts, in particular almonds, preferably in the form of puree;
from 10 to 20% of vegetable fat, in particular copra or rapeseed oil;
from 8 to 15% of a starch source such as vegetable flour or starch;
from 1 to 5% of vegetable food fibres, in particular psyllium and possibly other fibres, in particular inulin;
up to 3.5% of a natural acidifying ingredient, in particular an acidifier of the concentrated lemon juice type; according to a particular embodiment which does not use a source of natural calcium, the acidifier may be used in a lower content which may be up to 1.8%;
up to 2.5%, preferably less than 2% of food salt;
up to 30% of other raw materials, preferably vegetable, such as vegetable or fruit purees or pieces, cereals, seeds or herbs, aromas;
optionally, ferments, in particular in an amount of 0.01 to 0.1%, in particular used to ferment all or part of the crushed nut;
water, between 40% and 75%, in particular between 40% and 55%.

In this and the subsequent embodiments, aromas may be present in the food product, in particular when said food product does not comprise ferments.

This product is characterized in particular by the characteristics of a cheese product, in particular a yellow color (which can be obtained if necessary by the presence of carrot juice), a smooth appearance, a firm and possibly deformable rheology.

According to an embodiment, the present invention relates to a vegetable food product analogous to unrefined solid cheeses, in particular the feta, comprising (percentages expressed by weight with respect to the total weight of the product):
from 12 to 20% of crushed nuts, in particular almonds, preferably in the form of puree;
from 12 to 20% of vegetable fat, in particular hard fat, in particular copra;
from 10 to 20% of a starch source such as vegetable flour and/or starch;
up to 3.5% of a natural acidifying ingredient, in particular an acidifier of the concentrated lemon juice type; according to a particular embodiment which does not use a source of natural calcium, the acidifier may be used in a lower content which may be up to 1.8%;
up to 2.5%, preferably less than 2% of food salt;
up to 30% of other raw materials, preferably vegetable, such as vegetable or fruit purees or pieces, cereals, seeds or herbs, aromas;
optionally, ferments, in particular in an amount of 0.01 to 0.1%, in particular used to ferment all or part of the crushed nut;
water, between 40% and 75%, in particular between 45% and 55%.

This product is characterized in particular by characteristics of a cheese product, in particular a white color, a less smooth appearance, a less firm rheology and a fresh to cheesy taste.

According to one embodiment, the present invention relates to a vegetable food product analogous to unrefined solid cheeses, in particular mozzarella, comprising (percentages expressed by weight with respect to the total weight of the product):
from 10 to 16% of crushed nuts, in particular almonds, preferably in the form of puree;
from 6 to 12% of vegetable fat, in particular hard fat, in particular copra;
from 5 to 10% of a starch source such as vegetable flour and/or starch;
from 1 to 5% of vegetable food fibres, in particular inulin and possibly supplemented by a psyllium fibre;
up to 3.5% of a natural acidifying ingredient, in particular an acidifier of the concentrated lemon juice type; according to a particular embodiment which does not use a source of natural calcium, the acidifier may be used in a lower content which may be up to 1.8%;
up to 2.5%, preferably less than 2% of food salt;
up to 30% of other raw materials, preferably vegetable, such as vegetable or fruit purees or pieces, cereals, seeds or herbs, aromas;
optionally, ferments, in particular in an amount of 0.01 to 0.1%, in particular used to ferment all or part of the crushed nut;
water, between 40% and 75%, in particular between 60% and 70%.

This product is characterized in particular by characteristics of a cheese product, in particular a white color, a smooth appearance, a firm and deformable rheology and a fresh to cheesy taste.

According to one embodiment, the present invention relates to a vegetable food product analogous to unrefined solid cheeses, in particular the logs, in particular the goat logs, or the soft doughs, comprising (percentages expressed by weight with respect to the total weight of the product):
from 10 to 15% of crushed nuts, in particular almonds, preferably in the form of puree;
from 10 to 16% of vegetable fat, in particular hard fat, in particular copra and/or cocoa butter;
from 6 to 15% of a starch source such as vegetable flour and/or starch;
up to 3.5% of a natural acidifying ingredient, in particular an acidifier of the concentrated lemon juice type; according to a particular embodiment which does not use a source of natural calcium, the acidifier may be used in a lower content which may be up to 1.8%;
up to 2.5%, preferably less than 2% of food salt;
up to 30% of other raw materials, preferably vegetable, such as vegetable or fruit purees or pieces, cereals, seeds or herbs, aromas;
optionally, of ferments, in particular in an amount of 0.01 to 0.1%, in particular used to ferment all or part of the crushed nut;
water, between 40% and 75%, in particular between 50% and 70%.

This product is characterized in particular by characteristics of a cheese product, in particular a white to yellow color, a smooth appearance, a more or less firm and/or deformable rheology.

According to an embodiment, the present invention relates to a vegetable food product analogous to melted cheese, in particular melted cheese portions, comprising (percentages expressed by weight with respect to the total weight of the product):
from 12 to 20% of crushed nuts, in particular almonds, preferably in the form of puree;
from 12 to 22% of vegetable fat, in particular hard fat, in particular copra;
from 6 to 14% of a starch source such as vegetable flour and/or starch;
from 0.1 to 5% of vegetable food fibres, in particular inulin and possibly supplemented by a psyllium fibre;
up to 3.5% of a natural acidifying ingredient, in particular an acidifier of the concentrated lemon juice type; according to a particular embodiment which does not use a source of natural calcium, the acidifier may be used in a lower content which may be up to 1.8%;
up to 2.5%, preferably less than 2% of food salt;
up to 30% of other raw materials, preferably vegetable, such as vegetable or fruit purees or pieces, cereals, seeds or herbs, aromas;
optionally, ferments, in particular in an amount of 0.01 to 0.1%, in particular used to ferment all or part of the crushed nut;
water, between 40% and 75%, in particular between 52% and 62%.

According to an embodiment, the present invention relates to a vegetable food product analogous to sweet cheeses, in particular to fruits, comprising (percentages expressed by weight with respect to the total weight of the product):
from 8 to 15% of crushed nuts, in particular almonds, preferably in the form of puree;
from 10 to 16% of vegetable fat, in particular hard fat, in particular copra and/or cocoa butter;
from 4 to 12% of a starch source such as vegetable flour and/or starch;
up to 15% of sugar, in particular 5 to 12% of sugar;
up to 3.5%, in particular up to 0.5%, more particularly up to 0.2%, of a natural acidifying ingredient, in particular an acidifier of the concentrated lemon juice type; according to a particular embodiment which does not use a source of natural calcium, the acidifier may be used in a lesser content which may be up to 1.8%;
up to 30% of other raw materials, in particular from 15 to 25%, preferably vegetable, such as vegetable or fruit purees or pieces, cereals, seeds or herbs, aromas, more preferably of the fruit puree type, in particular red fruit, e.g. raspberry, or tomato;
water, between 40% and 75%, in particular between 40% and 60%.

Preferably, this food product does not contain any other ingredient than those listed below; in particular, it is free of any product of animal origin, in particular proteins, lactose, and food additives.

By food additive is meant a substance added to the food for a technological purpose: to improve its preservation, to reduce the oxidation phenomena, to color the commodities, to reinforce its taste, etc., it can be coloring agents (including whitening agents), preservatives, antioxidants, acidifiers/acidity correctors and texture agents (stabilizer, emulsifier, thickener, gelling agent). The use of food additives is governed by Regulation (EC) No 1333/2008 and these substances are identified by a code in the format “E” followed by a number.

The food product according to the invention is also free of any soybean-based ingredients. In addition, the food product according to the invention does not contain any protein isolate or concentrate, whether of animal or vegetable origin, nor any cereal or leguminous.

Nuts: the food product according to the invention consists of a base of one or more nuts, for example chosen from: the almond, the hazelnut, the walnut, the cashew nut, the pecan, the Brazil nut, the Macadamia nut, alone or in a mixture; preferably, it is a nut puree, preferably white almonds. A puree is a preparation of finely crushed nuts without any added ingredients, preferably resulting from a very fine crushing method (median particle size of less than 50 μm) and carried out on peeled, blanched and unroasted nuts.

According to one embodiment, the nut is, or the nuts comprise, almonds.

The almond is capable of allowing, if necessary, to obtain cheese analogs having an aromatic profile devoid of undesirable notes, that is to say in particular notes not belonging to the notes of the world of the cheeses, and/or cheese analogs optically resembling milk.

Surprisingly, the almond allows also to be used to obtain a wide range of aromatic profiles depending on the strains chosen. This allows to cover a whole world of cheeses through the development of fruity, floral, cream, animal, propionic, blue notes etc.

According to a preferred embodiment, the vegetable food product according to the invention is prepared with a blanched almond puree and which, coupled with a mixing and shearing method and the addition of other ingredients, allows the obtaining of more or less firm and/or deformable solid textures.

Depending on the desired firmness and/or nutritional composition of the finished product, the almond puree content can be modulated to reduce or increase the dry extract and in particular the fat and protein content.

Vegetable fat: different sources of vegetable fats can be used: oils such as rapeseed oil, sunflower oil, olive oil, grape seed oil, linseed oil, hemp oil, etc., and hard fats such as copra, cocoa butter, shea butter, etc., a mixture of different vegetable fats can be used.

The choice of the vegetable fat or the vegetable fats depends in particular on the texture of the desired finished product as well as their saturated fatty acid content, which impacts the nutritional profile of the finished product.

Thus, the fats of the liquid type at room temperature will be preferred for softer and more flexible products while solid oils at room temperature will be preferred for firmer products.

According to a preferred embodiment, the vegetable fats used in the scope of the products such as feta, mozzarella, slices or logs are the hard vegetable oils, i.e. fats that are solid at room temperature (about 20° C.) and having a high saturated fatty acid content: for example, the saturated fatty acid content is about 50% for the palm oil, >90% for the copra and >45% for the shea butter.

According to a preferred embodiment, the vegetable fats used in the scope of the toastinette or portioned-type products are the fluid vegetable oils, i.e. fats that are liquid at room temperature (about 20° C.) and therefore having a saturated fatty acid content of <15%. For example, the saturated fatty acid content is less than 10% for the rapeseed oil, less than 12% for less than 15% for the sunflower oil; advantageously and despite the known sensitivity of oils to oxidation and the various thermal treatments carried out during the preparation of the product (pasteurization of the mix and hot dosing), the finished product in its packaging is stable over time and no rancid note is perceptible at the end of conservation; preferably, the vegetable oil is chosen from the rapeseed oil, the sunflower oil and the olive oil or their mixture.

As with nut or seed puree, the percentage of fat used directly impacts the texture/firmness of the finished product.

Ferments: they can be used to give taste and/or acidify the mixture, replacing all or part of the acidifier. Various ferments can be incorporated into the formulation and are known to the person skilled in the art. These may in particular include lactic ferments including Lactococcus lactis ssp lactis and/or cremoris, Lactococcus lactis ssp lactis biovar diactylactis, Leuconostoc lactis, Leuconostoc mesenteroides and/or subspecies, Leuconostoc pseudomesenteroides Streptococcus thermophilus, Lactobacillus delbrueckii ssp bulgaricus, Lacticaseibacillus casei, Levilactobacillus brevis, Lacticaseibacillus rhamnosus, Lacticaseibacillus paracasei, Lactobacillus acidophilus Lactobacillus helveticus or Pediococcus pentosaceus, Pediococcus acidilactici, Lactiplantibacillus plantarum, Hafnia alvei, and/or refining ferments of the genus Propionibacterium and/or of the species Brevibacterium linens, and/or yeasts of the genera Kluyveromyces lactis, Debaromyces hansenii, Saccharomyces cerevisiae, Torulaspora delbrueckii or other species of yeasts and fungi, such as Penicillium roquefortii, alone or in mixture. The ferments can be added at different steps of the method in the form of a leaven composed of a fermented vegetable raw material. It is also possible to add the concentrated ferments directly to the cooled product before dosing.

Various lactic ferments can be used, in particular the commercial products such as Danisco® VEGE Cultures (IFF-DuPont N&B), HOLDBAC® YM VEGE (IFF-DuPont N&B).

According to an embodiment, the vegetable food product according to the invention comprises:
crushed nuts, preferably in the form of puree and preferably almond puree; added with:
at least one vegetable fat;
at least one source of starch;
at least one natural acidifying ingredient, in particular an acidifier such as concentrated lemon juice;
ferments;
optionally, at least one source of vegetable food fibres; and
water.

More specifically, the present invention relates to a vegetable food product comprising (percentages expressed by weight with respect to the total weight of the product):
from 5 to 40%, preferably between 13% and 30% of crushed nuts, preferably in the form of a puree. The particles of said puree preferably have a median particle size measured by laser particle size measurement of less than or equal to 50 μm;
from 5 to 35% of vegetable fat, preferably from 5 to 30% and even more preferably from 5 to 20%;
at least 3% protein and more preferably between 4 and 10% protein
from 0.5 to 20%, preferably 1 to 15%, of a starch source such as vegetable flour or starch;
up to 30% of other raw materials, preferably vegetable, such as vegetable or fruit purees or pieces, cereals, seeds or herbs, aromas;
up to 8% of vegetable food fibres;
optionally, a natural source of calcium, preferably of the Lithothamnion type, in particular at a content of between 0.5 and 1%;
up to 3.5% of a natural acidifying ingredient, in particular an acidifier of the concentrated lemon juice type; according to a particular embodiment which does not use a source of natural calcium, the acidifier may be used in a lower content which may be up to 1.8%;
up to 2.5%, preferably less than 2% of food salt;
ferments, in an amount of 0.01 to 1%, in particular 0.01 to 0.1 or 0.2%, in particular used to ferment all or part of the crushed nut;
water, between 40% and 75%, preferably around 55%.

According to a particular embodiment, the ferments are chosen from Lactococcus lactis ssp lactis, Lactococcus lactis ssp cremoris, Lactococcus lactis ssp lactis biovar diactylactis, Leuconostoc lactis, Leuconostoc mesenteroides, Leuconostoc pseudomesenteroides Streptococcus thermophilus, Lactobacillus delbrueckii ssp bulgaricus, Lacticaseibacillus casei, Levilactobacillus brevis, Lacticaseibacillus rhamnosus, Lacticaseibacillus paracasei, Lactobacillus acidophilus, Lactobacillus helveticus, Pediococcus pentosaceus, Pediococcus acidilactici, Lactiplantibacillus plantarum, Hafnia alvei, Propionibacterium, Brevibacterium linens, Kluyveromyces lactis, Debaromyces hansenii, Saccharomyces cerevisiae, Torulaspora delbrueckii, Penicillium roquefortii, and mixtures thereof.

The addition of ferments to the product according to the invention does not have the effect of texturizing it by a coagulation phenomenon for example. The main effect of this addition is to improve the sensory profile of the finished product by bringing it closer to the dairy referent, which may include a contribution to the acidification of the product, which plays a role in the perception of freshness of the product.

In the case of the preliminary preparation of a fermented vegetable matrix, also called leaven, it can be obtained in the following way: a nut or a mixture of nuts, in the form of a crushed or puree product, preferably almond puree, is added with water so as to obtain a mixture containing 5 to 30% of nuts and then thermally treated in order to eliminate the indigenous flora. This mixture is then fermented to obtain a leaven, as mentioned in all the examples under the step “A”. This base is inoculated with one or more microorganisms known to the person skilled in the art as being capable of imparting dairy and/or cheesy notes, including “fresh” and/or “cream” and/or “butter” and/or “blue” and/or “fruity” and/or “refined” and/or “animal” notes, for example of the goat type, to the fermented product by fermentation. These strain cocktails can be composed of one or more strains, of one or more species including the following species: Lactococcus lactis ssp lactis, cremoris, Lactococcus lactis ssp lactis biovar diactylactis, Leuconostoc lactis, and/or Leuconostoc mesenteroides, Streptococcus thermophilus, Lactobacillus delbrueckii ssp bulgaricus, Lacticaseibacillus casei, Levilactobacillus brevis, Lacticaseibacillus rhamnosus, Lacticaseibacillus paracasei, Lactobacillus acidophilus, Lactobacillus helveticus Pediococcus pentosaceus, Pediococcus acidilactici, Lactiplantibacillus plantarum, the genus Propionibacterium, the species Brevibacterium linens, Hafnia alvei, yeasts including the genera Kluyveromyces lactis, Debaromyces hansenii, Saccharomyces cerevisiae, Torulaspora delbrueckii, or other species of yeasts and/or fungi, such as Penicillium roquefortii.

The mixture is then incubated at a temperature favorable to the growth of the inoculated microorganism or the inoculated microorganisms within a temperature range comprised between 20° C. and 45° C. The incubation period is between 15 and 48 hours.

The leaven is then incorporated at the time of mixing of the vegetable materials of the preparation of the unrefined solid cheese analogs, in particular up to 60% or less of the final mixture, more particularly up to 5 to 60% of the final mixture.

Source of starch: this ingredient may be chosen from the rice flour, the chickpea flour, the pea flour, the fababean flour, the bean flour, the lupin flour, the lentil flour, the chestnut flour, the rice starch, the wheat starch, the corn starch, the tapioca starch, the potato starch etc. preferably the rice flour and/or the potato or manioc fecula is used. The rice flour, for example, is pregelatinized.

Because of its high starch content (80%), the rice flour is an interesting ingredient to offer Clean Label products without additives. Its white appearance and its relatively neutral taste compared to other flours allows to obtain products very close in appearance and taste to solid cheeses such as feta or mozzarella. Finally, the absence of gluten and its non-allergenicity are interesting properties.

For the same reasons, the potato and/or manioc fecula is an ingredient of interest to offer smooth and melting textures without strong impact on the color and the taste.

In addition to the hot viscosity and the organoleptic properties, another criterion that can be taken into account for the choice of the rice flour and/or fecula references is the differences in retrogradation observed. The retrogradation is a phenomenon of recrystallisation of the starch (composed of amylopectin and amylose chains) during the conservation which conducts to a progressive hardening of the product, whose texture becomes less soft and more crumbly, which is not always desired and which may not be appreciated by the consumer.

Several flour and starch references were tested and clearly showed significant differences in the behavior of the products during aging. This difference may be due to the origin of the product, its composition, or the preparation method used by the supplier. The choice of the type, origin and reference of the starch sources can have impacts on the texture and the taste of the product that the person skilled in the art will be able to adjust according to his objectives and preferences, in connection with the desired firmness, the shelf life and the mode of use desired for this product.

The references of potato or manioc starch presenting the least retrogradation over time are preferred within the scope of the present invention in that they allow to propose firm and sliceable textures while remaining at acceptable dosages and this with a stability of texture of the products during the conservation at 4° C.-10° C.

Other raw materials, preferably vegetable: these raw materials are distinct from the other vegetable ingredients of the recipe (nut puree, oil, flour or starch, fibres); they complement the other vegetable ingredients listed and may be chosen from among garlic, fine herbs, Provencal herbs, spices, seeds, calcium such as an extract of Lithothamnion, fruits, vegetables and cereals in the form of inclusions, dough or purees, aromas (for example to give a cream, butter, goat, Emmental, Cheddar or ewe typicity), etc.

Vegetable food fibres: the food fibres usable in the scope of the invention are:
the soluble fibres which may be weakly texturizing, such as chicory fibres (inulins and fructooligosaccharides), resistant dextrins or any other indigestible oligosaccharide of vegetable origin and/or the texturizing fibres such as psyllium, linseed or chia seed fibres, or other natural mucilages. Unlike the soluble fibers mentioned above, the psyllium and the other mucilaginous fibers are polysaccharides that greatly increase the texture of the finished product and/or the deformation at break. The type of soluble fibres and the quantity implemented can be adapted by the person skilled in the art according to the desired effect.
Optionally, it is also possible to use insoluble or partially soluble fibres, provided they have a particle size and shape that makes them undetectable in the mouth and a low water retention capacity; preferably, the soluble fibres are used.

A mixture of several vegetable food fibres can be used.

According to a particular embodiment, the vegetable food fibres are chosen from soluble fibres, such as chicory fibres, resistant dextrins and psyllium or other mucilaginous fibres such as linseed or chia seed fibres, and mixtures thereof.

In a more particular embodiment, the vegetable food fibres comprises or consists of psyllium.

The use of vegetable fibres allows to improve the nutritional profile of the finished product as well as providing texturizing functionality in the case of the psyllium and the other mucilaginous fibres.

Surprisingly, the psyllium fibre has been identified as one of the possible levers for obtaining firm and soft textures very reminiscent of the pressed dough textures. The addition of 1 to 4% of this fibre in mozzarella analogs, slices of pressed dough or even toastinettes can allow to find the product signatures in terms of more or less elastic textures depending on the dosage and is therefore a key element in these recipes.

According to a particular embodiment, the present invention relates to a vegetable food product analogous to unrefined solid cheeses, comprising:
from 5 to 40% of crushed nut puree;
from 5 to 30% of vegetable fat;
up to 2.5% of food salt;
optionally, up to 1% of ferments;
from 0.5% to 20% of a starch source;
up to 30% of other raw materials such as vegetables or fruits purees or pieces, cereals, seeds, aromas, or herbs;
optionally, a natural source of calcium, preferably of the Lithothamnion type, in particular at a content of between 0.5 and 1%;
up to 8% of vegetable food fibres;
up to 3.5% of a natural acidifying ingredient, in particular an acidifier of the concentrated lemon juice type;
between 40% and 75% water.

According to a particular embodiment, the present invention relates to a vegetable food product analogous to unrefined solid cheeses as defined above, comprising a natural source of calcium, preferably of the Lithothamnion type, in particular at a content of between 0.5 and 1%.

According to a more particular embodiment, the present invention relates to a vegetable food product analogous to unrefined solid cheeses, comprising:
from 5 to 40% of crushed nut puree;
from 5 to 30% of vegetable fat;
up to 2.5% of food salt;
optionally, up to 1% of ferments;
from 0.5% to 20% of a starch source;
up to 30% of other raw materials such as vegetables or fruits purees or pieces, cereals, seeds, aromas, or herbs;
a natural source of calcium, preferably of the Lithothamnion type, in particular at a content of between 0.5 and 1%;
up to 8% of vegetable food fibres;
up to 3.5% of a natural acidifying ingredient, in particular an acidifier of the concentrated lemon juice type;
between 40% and 75% water.

According to a particular embodiment, the present invention relates to a vegetable food product analogous to unrefined solid cheeses, comprising:
crushed nuts, preferably in the form of puree and preferably almond puree; added with:
at least one vegetable fat;
at least one source of starch;
at least one natural acidifying ingredient;
at least one source of vegetable food fibres, said at least one source being in particular a source of psyllium; and
water;

the unrefined solid cheeses being chosen in particular from mozzarella, pressed doughs, in particular in slices, and melted cheeses, in particular in slices.

A combination of different fibers can also be considered to play on both the nutritional fiber content and the desired functionality. The choice of the origin, the reference and the dosing of the fibres can have impacts on the texture and the taste that the person skilled in the art can adjust according to his objectives and preferences.

Acidifier: concentrated lemon juice is preferred.

This ingredient allows to obtain a final pH of the product between 4.0 and 5.2 in order to ensure both the microbial stability of the product during the conservation and to provide an acidity on the organoleptic profile.

Nutritional composition of the unrefined solid cheeses according to the invention:

| | | | | Of which | | |
|---|---|---|---|---|---|---|
| | | | | saturated | | |
| | Energy | Protein | Fat | fatty acids | Carbohydrates | Fibres |
| | (kcal) | (%) | (%) | (%) | (%) | (%) |
| Range | 150-350 | 3-12 | 8-32 | 1-25 | 1-20 | 0.5-8 |

The unrefined solid cheese analogs according to the invention have the following characteristics:
a color as close as possible to the dairy referent, i.e. white for the feta, mozzarella, melted portions, soft doughs and unrefined logs analogs, and ochre/yellow or orange for the pressed dough or toastinettes analogs;
a melting texture but sufficiently firm and/or deformable to be sliced and to conserve at least part of its shape during the use
a taste as dairy/cheesy as possible, without any undesirable vegetable taste.

Aromatized versions with distinctive colors and tastes, going beyond the known codes of cheese, can of course be envisaged, for example with the addition of vegetable raw materials obtained from carrots, beetroot, green beans, etc.

“Solid cheese analogs” means, in particular, a vegetable food product which does not collapse on itself during the cutting and which does not leave a trace on the cutting means during the cutting.

The cutting can be performed in particular by means of a knife or a guillotine and allows to generate pieces or slices.

According to a particular embodiment, the present invention relates to a vegetable food product analogous to unrefined solid cheeses, which are chosen from mozzarella, melted cheeses, in particular in portions or slices, pressed doughs, in particular in slices, logs and fresh soft doughs.

In a particular embodiment, the vegetable food product comprises only ferments for aromatic purposes.

The method for preparing the product according to the invention comprises the following steps:

A) optionally, preparing a fermented vegetable raw material by fermentation of a part or all of the crushed nuts in their rehydrated and thermally treated form prior to the inoculation of the ferments;
The aim of this step is to improve the organoleptic profile of the finished product by providing a cheesy/dairy typicity. The nut is preferably the almond.
The resulting fermented product may be added in the step B) or between the steps D) and G).
B) mixing of the raw materials, which may comprise the fermented vegetable raw material obtained in the step A), via a vigorous shearing and, optionally, preheating, e.g. by means of steam injection or a double-walled device;
This step allows the hydration of the ingredients, in particular the powders, until a generally liquid and homogeneous suspension is obtained; it is preferably lead at a temperature of between 20 and 65° C., for 1 to 30 minutes, with moderate to high stirring in a cooker or stirred tank; preferably, this step is lead in a cooker at approximately 50° C., for 5 minutes with moderate stirring.
C) thermal treating the mixture at a temperature between 75 and 90° C. with steam injection or double wall for 1 to 10 minutes under vigorous shearing;
This step allows the functionalization of the ingredients and the pasteurization of the raw materials; it is preferably made at 82° C. for 2 minutes.
The mixture can then optionally be transferred to a buffer tank and maintained at a temperature between 70° C. and 85° C.
D) optional degassing and optional homogenizing;
This step is preferably conducted between 50 bars and 600 bars, preferably 300 to 500 bars.
This step allows, among other things, a whiter coloring of the paste and the obtaining of a stable emulsion and the reduction of the size of particles in order to make the texture smooth, and if necessary, more greedy.
E) optionally, whipping, in particular from 1 to 30%, preferably from 1 to 15% to produce a slightly aerated texture;
This step allows to generate a discontinuous texture and a more or less heterogeneous aspect and thus to propose textures close to the dairy referents such as the mozzarella or the feta cheese; it can be conducted by nitrogen injection on a continuous whipper with whipping rates ranging from 1% to 30%.
The whipping ratio for a given volume is defined as the difference between the mass of the non-whipped product and the mass of the whipped product, this value being related to the mass of the non-whipped product and expressed in %.
F) optionally, adding other raw materials, preferably vegetable (herbs, aromatic ingredients, markers, fermented vegetable raw material, etc.);
Depending on the whipping technologies, the steps E) and F) can be reversed.
G) hot dosing the finished product in its packaging or in an intermediate container (barrel/skin/bag . . . ); the hot dosing is conducted at a temperature above 70° C., preferably between 74 and 80° C.;
H) cooling between 4 and 10° C.;
I) optionally, in the case of a dosing in an intermediate container, adding other, preferably vegetable, raw materials (aromatics) and/or ferments, followed by cold dosing of the product in its final packaging.
The cold dosing of the product in its final packaging can be carried out as follows:
J) extruding/molding the cooled curd to form the finished product;
K) Coating for a visual or organoleptic purposes.
The ingredients can be added between 4 and 20° C., preferably at 10° C. This embodiment requires a choice of aromatic ingredients that are highly reduced in microbial load to ensure microbiological stability during the conservation of the product. The addition of ferments allows to improve the organoleptic profile of the product and/or the microbial stability of the finished product. The choice of appropriate ferments is known to the person skilled in the art.

In a particular embodiment, the method for preparing the product according to the invention comprises the following steps:

A) optionally, preparing a fermented vegetable raw material by fermentation of part or all of the crushed nuts in their rehydrated and thermally treated form prior to the inoculation of the ferments;
The aim of this step is to improve the organoleptic profile of the finished product by providing a cheesy/dairy typicity. The nut is preferably the almond.
The resulting fermented product may be added in the step B) or between the steps D) and G).
B) mixing of the raw materials, which may comprise the fermented vegetable raw material obtained in the step A), via a vigorous shearing and, optionally, preheating, e.g. by means of steam injection or a double-walled device;
This step allows the hydration of the ingredients, in particular the powders, until a generally liquid and homogeneous suspension is obtained; it is preferably lead at a temperature of between 20 and 65° C., for 1 to 30 minutes, with moderate to high stirring in a cooker or stirred tank; preferably, this step is lead in a cooker at approximately 50° C., for 5 minutes with moderate stirring.
C) thermal treating the mixture at a temperature between 75 and 90° C. with steam injection or double wall for 1 to 10 minutes under vigorous shearing;
This step allows the functionalization of the ingredients and the pasteurization of the raw materials; it is preferably made at 82° C. for 2 minutes.
The mixture can then optionally be transferred to a buffer tank and maintained at a temperature between 70° C. and 85° C.
D) optional degassing and homogenizing;
This step is preferably conducted between 50 bars and 600 bars, preferably 300 to 500 bars.
This step allows, among other things, a whiter coloring of the dough and the obtaining of a stable emulsion and the reduction of the size of particles in order to make the texture smooth.
E) optionally, whipping, in particular from 1 to 30%, preferably from 1 to 15% to produce a slightly aerated texture;
This step allows to generate a discontinuous texture and a more or less heterogeneous aspect and thus to propose textures close to the dairy referents such as the mozzarella or the feta cheese; it can be conducted by nitrogen injection on a continuous whipper with whipping rates ranging from 1% to 30%.
The whipping ratio for a given volume is defined as the difference between the mass of the non-whipped product and the mass of the whipped product, this value being related to the mass of the non-whipped product and expressed in %.
F) optionally, adding other raw materials, preferably vegetable (herbs, aromatic ingredients, markers, fermented vegetable raw material, etc.);
Depending on the whipping technologies, the steps E) and F) can be reversed.
G) hot dosing the finished product in its packaging or in an intermediate container (barrel/skin/bag . . . ); the hot dosing is conducted at a temperature above 70° C., preferably between 74 and 80° C.;
H) cooling between 4 and 10° C.;
I) optionally, in the case of a dosing in an intermediate container, adding other, preferably vegetable, raw materials (aromatics) and/or ferments, followed by cold dosing of the product in its final packaging.
The ingredients can be added between 4 and 20° C., preferably at 10° C. This embodiment requires a choice of aromatic ingredients that are highly reduced in microbial load to ensure microbiological stability during the conservation of the product. The addition of ferments allows to improve the organoleptic profile of the product and/or the microbial stability of the finished product. The choice of appropriate ferments is known to the person skilled in the art.

In another embodiment, and in particular in the scope of feta type products, smooth feta type for example, the method for preparing the product according to the invention comprises the following steps:

A) optionally, preparing a fermented vegetable raw material by fermentation of part or all of the crushed nuts in their rehydrated and thermally treated form prior to the inoculation of the ferments;
The aim of this step is to improve the organoleptic profile of the finished product by providing a cheesy/dairy typicity. The nut is preferably the almond.
The resulting fermented product may be added in the step B) or between the steps D) and G).
B) mixing of the raw materials, which may comprise the fermented vegetable raw material obtained in the step A), via a vigorous shearing and, optionally, preheating, e.g. by means of steam injection or a double-walled device;
This step allows the hydration of the ingredients, in particular the powders, until a generally liquid and homogeneous suspension is obtained; it is preferably conducted at a temperature of between 20 and 65° C., for 1 to 30 minutes, with moderate to high stirring in a cooker or stirred tank; preferably, this step is conducted in a cooker at approximately 50° C., for 5 minutes with moderate stirring.
C) thermal treating the mixture at a temperature between 75 and 90° C. with steam injection or double wall for 1 to 10 minutes under vigorous shearing;
This step allows the functionalization of the ingredients and the pasteurization of the raw materials; it is preferably made at 82° C. for 2 minutes.
The mixture can then optionally be transferred to a buffer tank and maintained at a temperature between 70° C. and 85° C.
D) optional degassing and homogenizing;
This step is preferably conducted between 50 bars and 300 bars, preferably 200 bars.
In order to obtain a more or less smooth and/or heterogeneous or even crumbly texture and thus get closer to the textures of certain dairy feta on the market, it is even possible to eliminate this degassing/homogenizing step.
E) Optionally, whipping, in particular from 1 to 30%, preferably from 1 to 15% to produce a slightly aerated texture;
This step allows to generate a discontinuous texture and a more or less heterogeneous aspect and thus to propose textures close to the dairy referents such as the mozzarella or the feta; it can be conducted by nitrogen injection on a continuous whipper with whipping rates ranging from 1% to 30%.
The whipping ratio for a given volume is defined as the difference between the mass of the non-whipped product and the mass of the whipped product, this value being related to the mass of the non-whipped product and expressed in %.
F) optionally, adding other raw materials, preferably vegetable (herbs, aromatic ingredients, markers, fermented vegetable raw material, etc.);
Depending on the whipping technologies, the steps E) and F) can be reversed.
G) hot dosing the finished product in its packaging or in an intermediate container (barrel/skin/bag . . . ); the hot dosing is conducted at a temperature above 70° C., preferably between 74 and 80° C.;
H) cooling between 4 and 10° C.;
I) optionally, in the case of a dosing in an intermediate container, adding other, preferably vegetable, raw materials (aromatics) and/or ferments, followed by cold dosing of the product in its final packaging. The ingredients can be added between 4 and 20° C., preferably at 10° C. This embodiment requires a choice of aromatic ingredients that are highly reduced in microbial load to ensure microbiological stability during the conservation of the product. The addition of ferments allows to improve the organoleptic profile of the product and/or the microbial stability of the finished product. The choice of appropriate ferments is known to the person skilled in the art.

In another embodiment, and in particular in the scope of feta type products, of crumbly type for example, the method for preparing the product according to the invention comprises the following steps:

A) optionally, preparing a fermented vegetable raw material by fermentation of part or all of the crushed nuts in their rehydrated and thermally treated form prior to the inoculation of the ferments;
The aim of this step is to improve the organoleptic profile of the finished product by providing a cheesy/dairy typicity. The nut is preferably the almond.
The resulting fermented product may be added in the step B) or between the steps D) and G).
B) mixing of the raw materials, which may comprise the fermented vegetable raw material obtained in the step A), via a vigorous shearing and, optionally, preheating, e.g. by means of steam injection or a double-walled device;
This step allows the hydration of the ingredients, in particular the powders, until a generally liquid and homogeneous suspension is obtained; it is preferably lead at a temperature of between 20 and 65° C., for 1 to 30 minutes, with moderate to high stirring in a cooker or stirred tank; preferably, this step is lead in a cooker at approximately 50° C., for 5 minutes with moderate stirring.
C) thermal treating the mixture at a temperature between 75 and 90° C. with steam injection or double wall for 1 to 10 minutes under vigorous shearing;
This step allows the functionalization of the ingredients and the pasteurization of the raw materials; it is preferably made at 82° C. for 2 minutes.
The mixture can then optionally be transferred to a buffer tank and maintained at a temperature between 70° C. and 85° C.
E) Whipping, in particular from 1 to 30%, preferably from 1 to 15% to produce a slightly aerated texture;
This step allows to generate a discontinuous texture and a more or less heterogeneous aspect and thus to propose textures close to the dairy referents such as mozzarella or feta; it can be conducted by nitrogen injection on a continuous whipper with whipping rates ranging from 1% to 30%.
The whipping ratio for a given volume is defined as the difference between the mass of the non-whipped product and the mass of the whipped product, this value being related to the mass of the non-whipped product and expressed in %.
F) optionally, adding other raw materials, preferably vegetable (herbs, aromatic ingredients, markers, fermented vegetable raw material, etc.);
Depending on the whipping technologies, the steps E) and F) can be reversed.
G) hot dosing the finished product in its packaging or in an intermediate container (barrel/skin/bag . . . ); the hot dosing is conducted at a temperature above 70° C., preferably between 74 and 80° C.;
H) cooling between 4 and 10° C.;
I) optionally, in the case of a dosing in an intermediate container, adding other, preferably vegetable, raw materials (aromatics) and/or ferments, followed by cold dosing of the product in its final packaging.
The ingredients can be added between 4 and 20° C., preferably at 10° C. This embodiment requires a choice of aromatic ingredients that are highly reduced in microbial load to ensure microbiological stability during the conservation of the product. The addition of ferments allows to improve the organoleptic profile of the product and/or the microbial stability of the finished product. The choice of appropriate ferments is known to the person skilled in the art. This method does not include a degassing/homogenisation step, which can result in a more or less smooth and/or heterogeneous or even crumbly texture, thus getting closer to the textures of certain dairy feta on the market.

Table 1 lists the unit operations that can be implemented in the method according to the invention and indicated in the following examples:

TABLE 1

| | | | Preferred values |
|---|---|---|---|
| | | | (implemented in the |
| Unitary step | Function | Possible values | following examples) |
| Fermenting raw | Improving the | Fermenting nuts | Fermenting almond |
| materials | organoleptic profile | | juice |
| (optional step) | of the raw materials | | |
| A | by providing a | | |
| | cheesy/dairy typicity | | |
| Rehydrating, | Mixing the different | Mixing temperature | Cooker, mix 5 min at |
| Mixing and | ingredients so as to | between 20 and 65° C. | 50° C. |
| Preheating | obtain a globally | Mixing time between 1 | |
| (optional) | liquid and | min and 30 min | |
| ingredients | homogeneous | Cooker, stirred tank | |
| B | suspension | | |
| Pasteurizing | Functionalizing | 75° C. to 90° C. | 82° C., 2 min |
| C | ingredients by | From 1 to 10 min | |
| | thermal treatment and | | |
| | pasteurizing raw | | |
| | materials | | |
| Degassing | Stable emulsion, | 50 to 600 bars | 300-500 bars |
| (optional) and | particle size | | |
| Homogenizing | reduction for smooth | | |
| (optional) | texture and texturing | | |
| D | lever | | |
| Whipping | Generating an airy | Nitrogen injecting on a | Adjusting according |
| (Optional step) | texture to increase the | whipper with parameters | to the chosen |
| E | greediness | known to the person | whipping rate (0-30%) |
| | | skilled in the art | |
| Injecting | Bringing in markers | No limits for the | |
| ingredients | and/or a | aromatization. | |
| (Optional step) | aromatization | Max marker size | |
| F | | depending on the dosing | |
| | | nozzles | |
| Dosing (final | Dosing the product | Hot dosing > 70° C. | Hot dosing |
| packaging, mold | | | temperature between |
| block or barrel) | | | 72° C. and 80° C. |
| G | | | |
| Cooling | Cooling and texturing | T° C. = 4° C.-10° C. | Storage temperature |
| H | the product to obtain | | between 4° C. and |
| | a base or a finished | | 10° C. |
| | product | | |
| Injecting | Adding markers or | T° C. = 4-20° C. | T° C.: 0° C. |
| ingredients | herbs or one or more | | |
| (Optional step) and | ferments for | | |
| dosing in the final | aromatization and/or | | |
| packaging | improving the | | |
| I | conservation of the | | |
| | product | | |
| Cold extruding | Reforming the curd | Vemag-type Screw | Pusher typically |
| J | according to the | pusher | used in cheese or |
| | chosen format (log | | meat products |
| | for example) | | |
| Coating | Coating and | coating such as ashes, | |
| (optional step) | decorating the | herbs, seeds, spices, etc. | |
| K | product with | | |
| | ingredients for | | |
| | visual and | | |
| | organoleptic | | |
| | purposes | | |

In addition to the choice of the right raw materials allowing to optimize the organoleptic profiles, the choice of the steps of the method allows us to offer different types of products via a common line of equipment.

According to another aspect, the invention relates to a vegetable food product obtainable according to a method as defined above.

### FIGURES

FIG. 1 is a photograph of the product of example 1 which is an non-whipped feta analog;

FIG. 2 is a photograph of the product of example 2 which is an unrefined goat log analog;

FIG. 3 is a photograph of the product of example 3 which is a mozzarella analog;

FIG. 4 is a photograph of the product of example 4 which is a pressed dough slices analog.

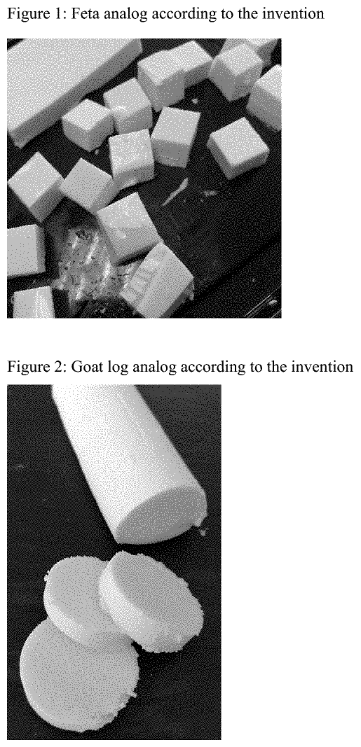

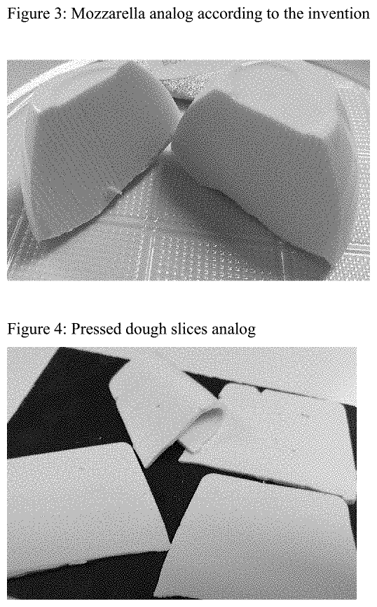

### EXAMPLES

Example 1: Feta analog: Water 51.05%, Almond puree 16%, Copra 16%, starch 9.7%, rice flour 4%, salt 1.8%, concentrated lemon juice 1.2%, natural aromas 0.25%

The method comprises the steps (A)-B-C-D-(F)-G-H. The steps indicated in the examples in brackets are optional.

As described in the document, an alternative is to eliminate the homogenization step (D) and/or to add a whipping step (E) to gain friability/heterogeneity and get even closer to a crumbly dairy feta texture.

In a variant of the formula, a preparation based on almond puree (15%) and water (85%) can be inoculated and fermented with strains known to the person skilled in the art to provide animal notes, during the step A. This fermented and aromatized vegetable material can be incorporated during the step B up to 2 to 30% in the final mixture to replace a part of the almond puree and water to remain at equivalent physicochemistry with a non-fermented version. The nutritional values of the product in Example 1 are shown in Table 2:

TABLE 2
Content per 100 g

| | |
|---|---|
| Energy (kcal) | 298 |
| Protein | 5.2 |
| Carbohydrates | 12 |
| Of which sugars | 1 |
| Lipids | 24 |
| Of which | 15 |
| Saturated Fatty | |
| Acids | |
| Fibres | 1 |

The addition of ingredients such as herbs or spices is a variation of this Nature formula, these ingredients being added in the step F.

The steps B) and C) can carried out in particular with a Stephan or Karl-Schnell type cooker.

Example 2: Unrefined goat log analog: Water 58.5%, almond puree 13%, copra 14%, starch 6.5%, rice flour 5%, concentrated lemon juice 1.5%, salt 1.1%, natural aroma 0.4%. 2 dosing types can be considered:
Dosing in a hot mold, cooling and demolding/packaging according to the following method:

(A)-B-C-D-(F)-G-H
Dosing of the product in barrel/pocket, cooling of the curd and cold forming in a molding machine to form a log/bag and packaging according to the following method:

(A)-B-C-D-G-H-(I)-J-(K).

In a variant of the formula, a preparation based on almond puree (10%), copra oil (2%) and water (88%) can be inoculated and fermented with strains known to the person skilled in the art to generate goat notes, during the step A. This fermented and aromatized vegetable material can be incorporated during the step B up to 2 to 30% in the final mixture to replace a part of the almond puree, copra oil and water to remain at equivalent physicochemistry with a non-fermented version.

Example 3: Mozzarella analog: 65.6% water, 13.2% almond puree, 9% copra, 5% fecula, 1.5% rice flour, 3.4% fibres, 1% salt, 1% concentrated lemon juice, 0.3% natural aroma. The method comprises the following steps: (A)-B-C-D-(F)-G-H

Example 4: Pressed dough analog: 48.9% water, 19% almond, 14% copra, 13% fecula, 2.5% psyllium, 1.3% salt, 1.1% concentrated lemon juice, 0.2% natural aroma, 0.2% yeast extract. You can add a coloring ingredient to bring a slight yellow note. The method comprises the following steps: (A)-B-C-D-(F)-G-H

The product dosed in block after being cooled and textured can then be sliced according to methods known to the person skilled in the art.

In a variant of the formula, a preparation based on almond puree (10%) and water (90%) can be inoculated and fermented with strains known to the person skilled in the art to provide cheese notes, for example of the propionic or umami type, during the step A. This fermented and aromatized vegetable material can be incorporated during the step B up to 2 to 30% in the final mixture to replace a part of the almond puree and water to remain at equivalent physicochemistry with a non-fermented version.

Example 5: Melted Toastinette analogs (which may also be known as individually wrapped slices (IWS) or slice on slice (SOS)):

51.6% water, 16% almond puree, 15% rapeseed oil, 10% fecula, 4.6% fibres (psyllium and inulin), 1.3% salt, 1.1% concentrated lemon juice, 0.3% natural aroma, 0.1% coloring ingredient. The method comprises the following steps: (A)-B-C-D-(F)-G-H.

The product being cooled and textured can then be sliced using methods known to the person skilled in the art.

Example 6: Portions of melted cheese analogs: 57% water, 14% almond puree, 17% copra, 3% rice flour, 6% potato starch, 1% inulin, 1% concentrated lemon juice, 0.8% salt, 0.2% natural aroma. The method comprises the steps: (A)-B-C-D-(F)-G-H.

In a variant of the formula, a preparation based on almond puree (20%) and water (80%) can be inoculated and fermented with strains known to the person skilled in the art in order to provide buttery, creamy or yoghurt-type dairy notes during the step A. This fermented and aromatized vegetable material can be incorporated during the step B up to 2 to 30% in the final mixture to replace a part of the almond puree and water to remain at equivalent physicochemistry with a non-fermented version.

Example 7: Sweet snack type: 40% water, 11% almond puree, 13% copra, 3.9% rice flour, 4% starch, 9% sugar, 0.1% concentrated lemon juice, 19% fruit puree (raspberry). The method comprises the steps: (A)-B-C-D-(F)-G-H.

Example 8: Unrefined Soft Dough analog: 12.7% water, 63.5% fermented almond milk (79.95% water, 20% almond puree, 0.05% lactic ferments), 12% dearomatized cocoa butter, 8% rice flour, 0.9% NaCl, 2.5% vegetable fiber, 0.2% natural aromas, 0.2% concentrated lemon juice. The method comprises the steps: (A)-B-C-D-G-H-K.

Example 9: Rheological characterization of the sliceable solids

Various finished products (dairy cheeses and products according to the invention) were sliced using an Instron universal traction-compression machine equipped with a knife-shaped geometry. It descends rapidly (10 mm/s) into the product to a distance of 20 mm in order to reproduce a slicing operation as it might be performed by a consumer. The maximum force at the end of the displacement, expressed in Newton (N), is the average of three measurements and is shown in Table 3.

| Product | Force (N) |
|---|---|
| Dairy feta 1 | 29 |
| Dairy feta 2 | 38 |
| Example 1 - Feta analog | 37 |
| Dairy goat log 1 | 41 |
| Example 2 | 35 |
| Dairy Mozzarella 1 | 12 |
| Example 3 | 10 |
| Dairy pressed dough 1 | 92 |
| Dairy pressed dough 2 | 150 |
| Example 4 | 110 |

The slicing forces of the products according to the invention mentioned in the examples are of the same order of magnitude as those of the dairy referents. The slicing resistance can be modulated as required by adjusting the formulation and manufacturing method parameters.

1. A vegetable food product analogous to unrefined solid cheeses, comprising:
crushed nuts, added with:
at least one vegetable fat;
at least one source of starch;
at least one natural acidifying ingredient;
optionally, at least one source of vegetable food fibres; and
water;
wherein the vegetable food product contains no added additives.

2. The vegetable food product according to claim 1, wherein the vegetable food product has a protein content greater than or equal to 3%.

3. The vegetable food product according to claim 1, not comprising protein concentrate and/or isolate.

4. The vegetable food product according to claim 1, wherein the crushed nuts are further added with ferments.

5. The vegetable food product according to claim 1 not comprising soybean.

6. The vegetable food product according to claim 1, further comprising (percentages expressed by weight with respect to the total weight of the product):
from 5 to 40% of crushed nut puree;
from 5 to 35% of vegetable fat;
from 0.5% to 20% of a starch source;
up to 30% of other raw materials, including vegetable or fruit purees or pieces, cereals, seeds or herbs, aromas;
up to 8% of vegetable food fibres;
optionally, a natural source of calcium;
up to 3.5% of a natural acidifying ingredient;
up to 2.5% of food salt;
optionally, up to 1% of ferments; and
between 40% and 75% of water.

7. The vegetable food product according to claim 1, wherein the vegetable food product has:
a dry extract content of between 20 and 55%;
a pH between 4.0 and 5.2;
characteristics of a cheese product, including a white to yellow color, a more or less smooth appearance, a more or less firm and/or deformable rheology and/or a fresh to cheesy taste.

8. The vegetable food product according to claim 1, wherein the nut is almond.

9. The vegetable food product according to claim 1, wherein the starch source is a rice flour and/or a potato or cassava fecula.

10. The vegetable food product according to claim 9, wherein the rice flour is pregelatinized.

11. The vegetable food product according to claim 1, wherein the vegetable food fibres are selected from soluble fibres, including chicory fibres, resistant dextrins and psyllium or other mucilaginous fibres including linseed or chia seed fibres, and mixtures thereof.

12. A method for preparing the vegetable food product according to claim 1, comprising the following steps:
A) optionally, preparing a fermented vegetable raw material by fermentation of a part or all of crushed nuts, in their rehydrated and thermally treated form prior to the inoculation of the ferments;
B) mixing of the raw materials, comprising the fermented vegetable raw material obtained in the step A), via a vigorous shearing, and optionally preheating;
C) thermal treating the mixture at a temperature between 75 and 90° C. for 1 to 10 minutes under vigorous shearing;
D) optional degassing and optional homogenizing;
E) optionally, whipping;
F) optionally, adding other raw materials, including vegetable;
wherein the steps E) and F) can be reversed;
G) hot dosing at a temperature above 70° C. the finished product in its packaging or in an intermediate container;
H) cooling between 4 and 10° C.;
Optionally, in the case of a dosing in an intermediate container:
(I) adding other aromatic raw materials and/or ferments, including vegetable;
J) extruding/molding the cooled curd to form the finished product; and
K) coating for a visual or organoleptic purpose.

13. The vegetable food product according to claim 1, wherein the crushed nuts are in the form of a puree

14. The vegetable food product according to claim 1, wherein the vegetable food product has between 3 and 12% protein.

15. The vegetable food product according to claim 1, wherein the vegetable food product has between 4 and 10% protein.

16. The vegetable food product according to claim 2, not comprising protein concentrate and/or isolate.

17. The vegetable food product according to claim 4, wherein the crushed nuts are in the form of an almond puree, and wherein the at least one natural acidifying ingredient is concentrated lemon juice;

18. The vegetable food product according to claim 6, wherein the natural source of calcium is of the Lithothamnion type, at a content of between 0.5 and 1%, and wherein the natural acidifying ingredient is concentrated lemon juice;

19. The vegetable food product according to claim 2 not comprising soybean.

20. The vegetable food product according to claim 3 not comprising soybean.
